(19) United States
(12) Patent Application Publication
(10) Pub. No.: US 2022/0333396 A1
(43) Pub. Date: Oct. 20, 2022

(54) AUTOMATED VEHICULAR PARKING APPARATUS

(71) Applicant: Park Plus, Inc., Fairview, NJ (US)

(72) Inventor: Neal Dauber, Fairview, NJ (US)

(21) Appl. No.: 17/719,062

(22) Filed: Apr. 12, 2022

Related U.S. Application Data
(60) Provisional application No. 63/174,113, filed on Apr. 13, 2021.

(51) Int. Cl. E04H 6/06; E04H 6/42; B66F 7/28; B66F 7/04

(52) U.S. Cl. CPC E04H 6/06; E04H 6/424; B66F 7/28; B66F 7/04

(57) ABSTRACT

A parking apparatus has left and right vertical stanchions and a parking platform between the stanchions for supporting a parked vehicle. Carriages are mounted to opposite sides of the parking platform and have wheels that engage in channels formed in the stanchions so that the parking platform can be raised and lowered. The channels are configured to widen or tilt toward the bottom ends of the stanchions. These shapes of the channels near the bottom ends of the stanchions are configured relative to the carriages so that the parking platform tilts slightly forward when the parking platform is near the lowest position so that a vehicle can be driven on and off the parking platform. However, the engagement of the carriages and the stanchions cause the parking platform to tilt slightly rearward as the parking platform moves up to prevent the vehicle from rolling off the parking platform.

### CROSS REFERENCE TO RELATED APPLICATION

This application claims priority on U.S. Provisional Application No. 63/174,113 filed on Apr. 13, 2021, the entire disclosure of which is incorporated herein by reference.

### BACKGROUND

Field of the Invention The invention relates to an automated parking apparatus that enables two vehicles to parked vertically in a horizontal ground space or footprint corresponding to a size of one of the vehicles.

Description of the Related Art Urban areas continue to become populated more densely and typically offer fewer spaces for accommodating an increasing population of vehicles. Parking devices have been available for decades to permit two or more vehicles to be parked in a vertical array. An example of one such parking apparatus is disclosed in U.S. Pat. No. 4,772,172, the disclosure of which is incorporated herein by reference.

The parking apparatus disclosed in U.S. Pat. No. 4,772,172 has left and right longitudinal supports that are positioned securely on a horizontal surface. Left and right vertical stanchions extend up from the longitudinal supports. A parking platform is mounted for vertical movement along the stanchions between a lower position and an upper position. The parking platform that is in the lower position is between the left and right longitudinal supports and adjacent the ground surface or floor on which the longitudinal supports are positioned. As a result, a vehicle can drive onto the parking platform. The parking platform with the vehicle mounted thereon then can be elevated along the vertical stanchions and into a position that enables a second vehicle to be parked beneath the parking platform and between the left and right vertical stanchions. A mechanism is provided for selectively raising and lowering the parking platform. The mechanism shown in U.S. Pat. No. 4,772,172 includes left and right arrays of stabilizer bars and left and right piston-cylinder assemblies. The cylinder of each piston cylinder assembly is mounted pivotally to the upper end of the stanchion. The piston of each piston-cylinder assembly is mounted to one of the stabilizer bars. Movement of the piston into or out of the respective cylinder causes the parking platform to be raised or lowered.

The parking platform and the stanchions must be configured so that the front lip of the parking platform is at or very close to ground level when the parking platform is in its lower position so that a vehicle can be driven onto or off of the platform very easily. However, there is a concern that the parked vehicle could roll off the front edge of the parking platform as the parking platform is being raised or lowered.

In view of the above, an object of the invention is to provide a parking apparatus that enables a vehicle to be driven easily onto the parking platform while preventing the vehicle from sliding or rolling off the parking platform as the platform is being raised and lowered.

### SUMMARY

The invention relates to a parking apparatus with left and right vertical stanchions and a parking platform that can be raised and lowered along the stanchions. The front end of the parking platform defines a downwardly sloped lip that enables a vehicle to be driven onto the parking platform. The rear end of the parking platform includes a short vertical wall or curb that extends up on the parking platform to prevent the vehicle from being driven rearwardly off of the parking platform. The parking platform can be moved between a lower position and an upper position. The front lip of the parking platform is on or near a ground or floor surface when the parking platform is in the lower position to enable a vehicle to be driven onto the platform. The parking platform that is in the an upper position is elevated sufficiently from the ground or floor surface to enable a second vehicle to be parked beneath the parking platform.

The left and right stanchions may be supported on and extend vertically up from left and right longitudinal supports. Alternatively, the stanchions may be mounted securely directly in a floor of a parking lot or parking garage or may extend from the floor of a parking garage to the ceiling of the parking garage. Mechanisms are provided for raising and lowering the parking platform along the stanchions. The mechanisms can include arrays of stabilizer bars that cooperate with piston-cylinder assemblies similar to the arrangement shown in U.S. Pat. No. 4,772,172. However, other mechanisms can be provided, such as chains and sprockets, rack and pinion gear assemblies, worm gear assemblies or the like.

The stanchions preferably extend substantially vertically and linearly for a major part of their length. However, a lower portion of each stanchion includes a sloped portion that is angled to extend rearwardly at an acute angle from the vertical upper portion. In this regard, each stanchion may define a channel or rail, and a carriage may be mounted to each side of the parking platform with wheels or supports that roll or slide in each respective channel or along each rail. The supports of each carriage will follow the alignment of the channels or rails of the respective stanchion. As a result, the carriages of the parking platform will tilt slightly as the parking platform approaches the lowermost position thereby causing the front lip of the parking platform to move into a position on or substantially adjacent the supporting surface on which the parking apparatus is supported. Conversely, the carriages and the entire parking platform will tilt as the parking platform is elevated from the lowermost position, thereby causing the front lip of the parking platform to elevate slightly relative to the rear end of the parking platform. As a result, the parking platform will move and rotate into a non-horizontal position with the front end being slightly higher than the rear end as the parking platform begins moving toward the upper position. As a result, the alignment of the parking platform for a major part of its vertical movement will be sloped slightly rearwardly to prevent a vehicle from sliding or rolling off the parking platform, while still enabling a very easy movement of the vehicle onto or off of the parking platform when the parking platform is at its lowermost position.

### BRIEF DESCRIPTION OF THE DRAWINGS

FIG. 1 is a perspective view of a parking apparatus according to one embodiment of the invention.

FIG. 2 is a side elevational view of a lower part of the parking apparatus where the stanchion meets in the longitudinal support.

FIG. 3 is a side elevational view showing the parking platform slightly above its lowermost position.

FIG. 4 is a side elevational view showing the parking platform at its lowermost position.

FIG. 5 is an enlarged view showing the carriage of the parking platform engaged at the lower and of the stanchion.

### DETAILED DESCRIPTION

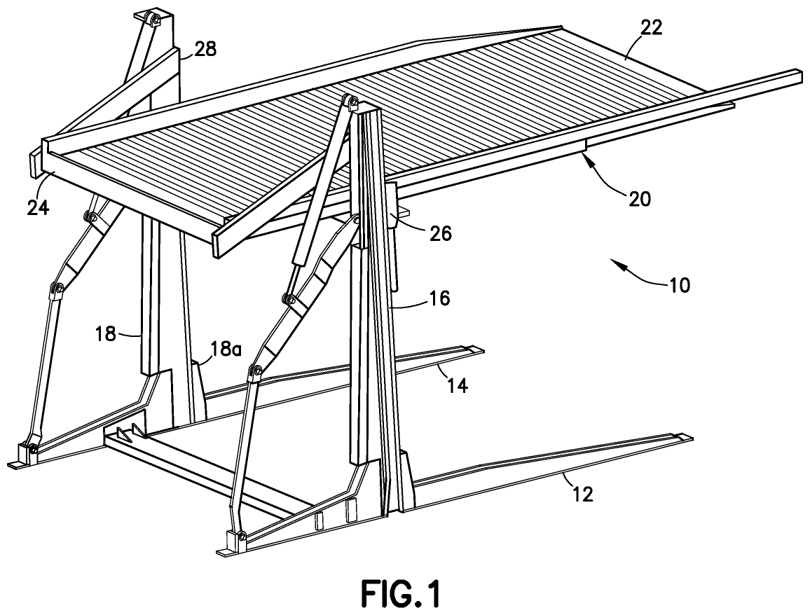

A parking apparatus according to one embodiment of the invention is identified by the numeral 10 in FIGS. 1-4. The parking apparatus 10 includes left and right horizontal supports 12 and 14 to be supported on a floor or ground surface of a parking facility. Left and right stanchions 16 and 18 extend substantially vertically up from the left and right supports 12 and 14. The stanchion 16 has a substantially vertical channel 17, and the stanchion 18 has an identically configured channel that is not visible in the figures. The channel 17 has a front wall 17f and a rear wall 17r. The front wall 17f of the channel 17 extends substantially straight and substantially vertically from the lower end of the stanchion 16 to the upper end of the stanchion 16. The rear wall 17r of the channel 17 in the stanchion 16 extends parallel to the front wall 17f for a major part of the height of the stanchion 16. However, the lower end of the rear wall 17r of the channel 17 in the stanchion 16 diverges from the front wall 17f so that the channel 17 becomes wider toward the bottom and in a region adjacent to the horizontal support 12. The stanchion 18 has an identically configured channel 17 with a rearwardly diverging rear wall adjacent the lower end of the stanchion 18

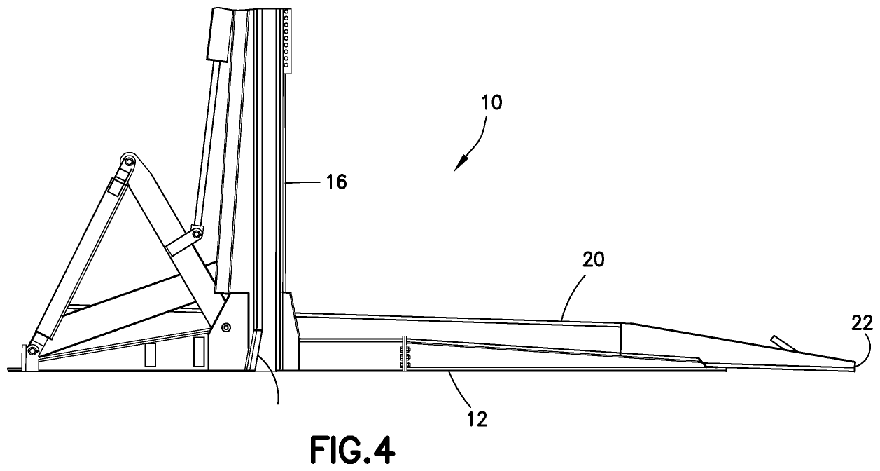

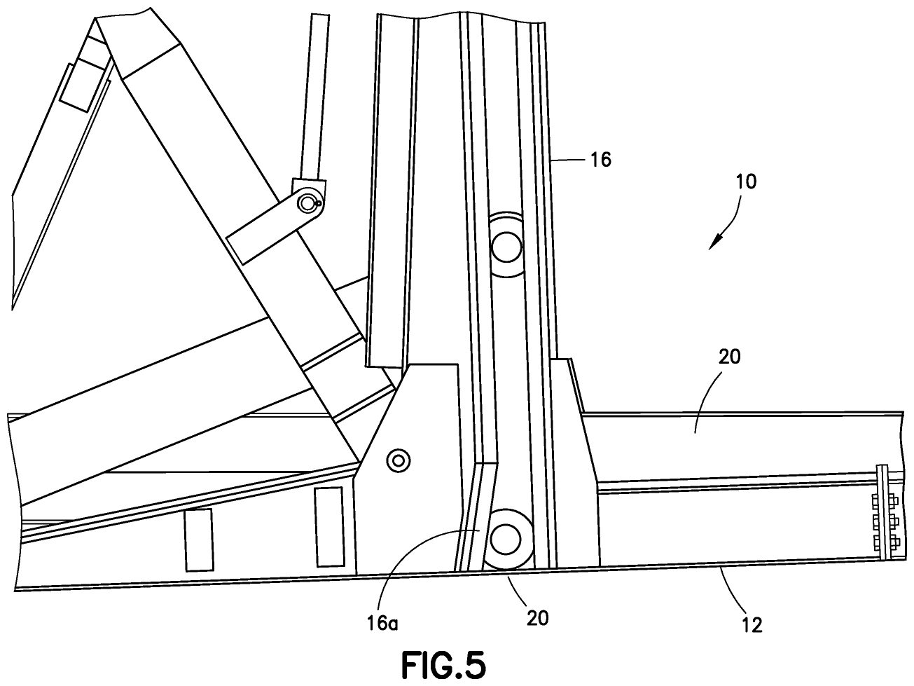

A parking platform 20 is mounted to the stanchions 16 and 18 and can move from an uppermost position, as illustrated in FIG. 1, to a lowermost position as illustrated in FIGS. 4 and 5. The parking platform 20 has wheels 21 mounted to carriages 26 and 28 at opposite sides of the parking platform 20. The wheels 21 are guided in the channels 17 of the respective stanchions 16, 18. A downwardly sloped lip 22 is formed at the front end of the parking platform 20, and a vertical wall or curb 24 extends up at the rear end of the parking platform 20.

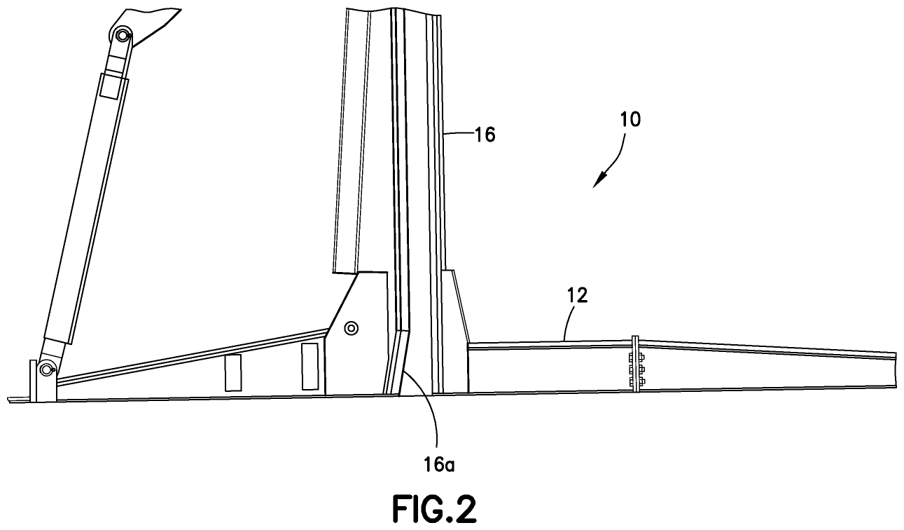

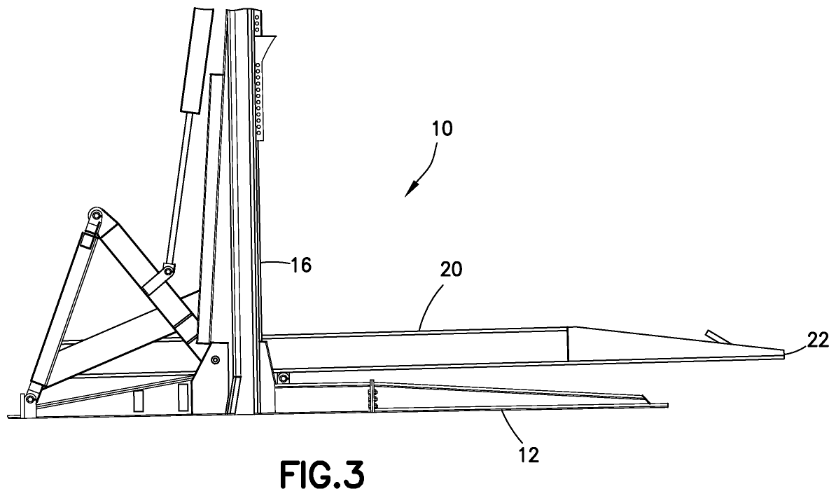

As noted above, and as shown most clearly in FIG. 2, the lower end of the channel 17 in each stanchion 16, 18 widens by configuring the lower part of the rear wall 17r in the respective channel 17 to diverge angularly rearward relative to the front wall 17f of the respective channel 17 at positions farther toward the bottom end of the respective stanchion 16, 18 and hence toward the corresponding longitudinal support 12, 14. The parallel and vertical alignment of the front and rear walls 17f, 17r of each channel 17 of each stanchion 16, 18 causes the parking platform 20 to maintain an alignment where the front lip 22 of the parking platform 20 is elevated slightly relative to the part of the parking platform 20 adjacent the rear curb 24 for a major portion of the vertical movement of the parking platform 20 along the stanchions 16, 18. This alignment is maintained by the fixed disposition and alignment of the carriages relative to the surfaces of the parking platform on which a vehicle will be supported. However, as shown most clearly in FIGS. 4 and 5, the wheels 21 of the carriages 26, 28 of the parking platform 20 that move along the channels 17 in the stanchions 16, 18 enter the parts of the channels 17 with the rearwardly diverging rear walls 17r as the parking platform 20 nears the lowermost position. Thus, the weight of the vehicle on the parking platform 20 cause the parking platform 20 to pivot slightly so that wheels 21 of the carriages 26, 28 ride along the diverging rear walls 17r of the channels 17 and so that the front lip 22 of the parking platform 20 moves into contact with or adjacent the supporting surface when the parking platform 20 is at its lowermost position. As a result, the vehicle easily can move onto and off of the parking platform 20 when the parking platform 20 is at its lowermost position. However, the wheels 21 in the carriages 26 and 28 of the parking platform move into the narrow portions of the channels 17 defined by the parallel front and rear walls 17f, 17r after a short upward movement away from the longitudinal supports 12 and 14 thereby causing the parking platform to tilt slightly rearward. Accordingly, the vehicle cannot slide or roll forwardly off the front end of the parking platform 20 once the parking platform 20 has been elevated slightly above the lowermost position, namely when the parking platform 20 is in any of the positions between those shown in FIGS. 1 and 3. The short vertical wall or curb 24 at the rear end of the parking platform 20 prevents the vehicle from sliding or rolling rearwardly off the parking platform 20 at any of its elevated positions between the position shown in FIG. 3 and the position shown in FIG. 1. The vertical extent of the rearwardly sloped lower portion rear wall 17r in the channel 17 of each stanchion 16, 18 preferably is no more than 1 foot in vertical height.

1. A parking apparatus, comprising:
left and right stanchions aligned substantially vertically; and
a parking platform between the stanchions for supporting a parked vehicle, the parking platform having opposite front and rear ends, and opposite left and right carriages engaged with the stanchions for vertical movement along the stanchions from a lower position to an upper position, wherein:
the stanchions and the carriages are configured so that the parking platform is horizontal or tilted forward when the parking platform is in the lower position and so that the parking platform is tilted rearward when the parking platform moves above the lower position to prevent the parked vehicle from rolling or sliding off the front end of the parking platform when the parking platform is above the lower position.

2. The parking apparatus of claim 1, wherein each of the stanchions has a channel extending substantially vertically along the respective stanchion, and wherein the left and right carriages have wheels engaged respectively in the channels of the left and right vertical stanchions.

3. The parking apparatus of claim 2, wherein the channel in each of the stanchions has opposite front and rear walls, the rear wall of each of the channels diverging away from the front wall of the respective channel at positions substantially adjacent lower ends of the channels, the wheels of the carriages following the diverging portion of the rear wall and thereby causing the parking platform to tilt so that the front end of the parking platform is substantially adjacent the ground surface on which the parking apparatus is supported.

4. The parking apparatus of claim 1, wherein the front end of the parking platform has a downwardly sloped front lip.

5. The parking apparatus of claim 1, wherein the rear end of the parking platform has an upwardly extending curb for preventing rearward movement of the vehicle from the parking platform.

6. The parking apparatus of claim 1, further comprising left and right horizontal supports supported on a ground or floor surface, the left and right stanchions having lower ends secured respectively to the left and right horizontal supports.

7. The parking apparatus of claim 6, further comprising left mechanisms connected to the carriages and operative to move the parking platform vertically along the stanchions.
